(19) United States
(12) Patent Application Publication
(10) Pub. No.: US 2013/0070457 A1
(43) Pub. Date: Mar. 21, 2013

(54) ILLUMINATING DEVICE

(71) Applicant: KABUSHIKI KAISHA TOSHIBA, Tokyo (JP)

(72) Inventors: Hideo NISHIUCHI, Hyogo-ken (JP); Izuru KOMATSU, Kanagawa-ken (JP); Daigo SUZUKI, Kanagawa-ken (JP); Kazuki TATEYAMA, Kanagawa-ken (JP)

(73) Assignee: KABUSHIKI KAISHA TOSHIBA, Tokyo (JP)

(21) Appl. No.: 13/622,952

(22) Filed: Sep. 19, 2012

(30) Foreign Application Priority Data
Sep. 20, 2011 (JP) 2011-204898

(51) Int. Cl. F21V 13/10; F21V 29/00

(52) U.S. Cl. 362/235; 362/249.02

(57) ABSTRACT

According to one embodiment, the illuminating device of the embodiment has a base part and multiple light emitting elements; the illuminating device includes a supporting part, which is arranged on one end of the base part, and which at least partially encloses an internal space. The supporting part also has an outer surface exposed to the ambient atmosphere. The multiple light emitting elements are disposed on the inner surface side of the supporting part so that at least light emitting surfaces of the light emitting elements are in contact with the supporting part.

### CROSS-REFERENCE TO RELATED APPLICATION

This application is based upon and claims the benefit of priority from Japanese Patent Application No. 2011-204898, filed Sep. 20, 2011; the entire contents of which are incorporated herein by reference.

### FIELD

Embodiments described herein generally relate to an illuminating device.

### BACKGROUND

In recent years, instead of incandescent light bulbs (filament light bulbs), illuminating devices which employ light emitting diodes (LEDs) as a light source have been adopted for practical applications.

Illuminating devices which use light emitting diodes have a longer lifetime and a lower power consumption, and for this reason, are expected to replace the existing incandescent light bulbs.

However, when light emitting diodes are used as the light source, the light distribution angle is narrower than that of incandescent light bulbs. This is undesirable.

In consideration of this problem, people have proposed an illuminating device having an expanded light distribution angle resulting from the arrangement of multiple light emitting diodes on a curved printed circuit board. However, for such an illuminating device, the ability to dissipate heat generated by the multiple light emitting diodes is poor. This poor heat dissipation limits the electric power that can be applied to the illuminating device for the production of light. Thus, the light output from the light emitting diodes may become less intense and the emission of light from the illuminating device is less than optimal.

### DESCRIPTION OF THE DRAWINGS

FIGS. 1A and 1B are schematic cross-sectional views illustrating an example of an illuminating device of an embodiment. FIG. 1A shows the illuminating device equipped with a supporting part which does not have an opening portion. FIG. 1B shows an illuminating device equipped with a supporting part having an opening portion formed therein.

FIGS. 2A and 2B are schematic views illustrating an example of a light source. FIG. 2A shows the illuminating device equipped with a supporting part which does not have an opening portion. FIG. 2B shows the illuminating device equipped with a supporting part with an opening portion formed thereon, the opening portion located at an end of the base part.

FIG. 3 is a perspective diagram illustrating an example of an illuminating device according to another embodiment.

FIGS. 4A and 4B are perspective diagrams illustrating an example of the illuminating device according to another embodiment. FIG. 4A shows the illuminating device equipped with a supporting part which does not have an opening portion. FIG. 4B shows the illuminating device equipped with a supporting part having an opening portion therein, the opening portion located at an end of the base part.

FIG. 5 is a schematic cross-sectional view illustrating an example of the illuminating device according to another embodiment.

FIGS. 6A to 6C are schematic views which each illustrate an example of the heat dissipation state in an illuminating device. FIG. 6A shows the case of a conventional illuminating device. FIG. 6B shows an illuminating device having the heat dissipating part shown in FIG. 4. FIG. 6C shows the illuminating device having the heat dissipating part and the opening portion shown in FIG. 5.

### DETAILED DESCRIPTION

In general, embodiments will be described with reference to the figures. The same reference numerals will be used in different figures to refer to the components that are common throughout the figures, and these common components will not be explained in detail.

According to an embodiment, there is provided an illuminating device with improved heat dissipation properties.

The illuminating device related to the embodiment has a base part and multiple light emitting elements. The illuminating device also has a supporting part, which is arranged on one end of the base part, an internal space, and an outer surface exposed to the ambient atmosphere. The multiple light emitting elements are disposed on the interior side of the supporting part so that at least a portion of the light emitting surfaces thereof are in contact with the supporting part.

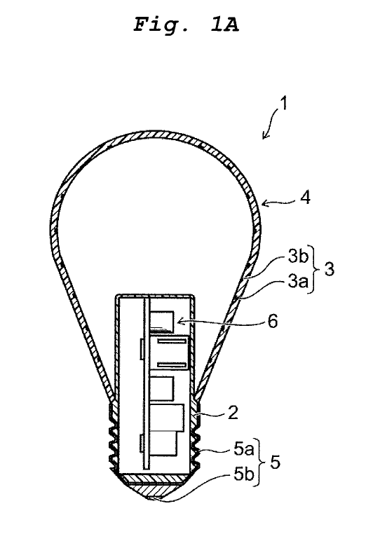

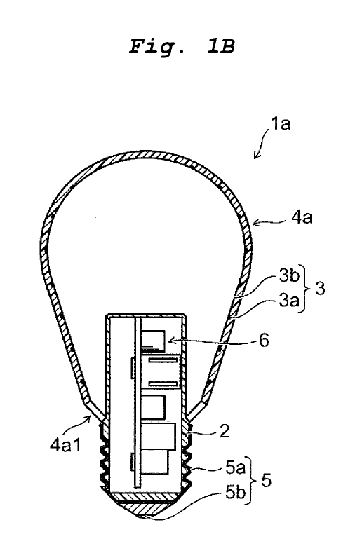

FIGS. 1A and 1B are schematic cross-sectional views illustrating an example of an illuminating device according to one embodiment.

FIG. 1A shows an illuminating device 1 equipped with a supporting part 4 without an opening portion and FIG. 1B shows an illuminating device 1a equipped with a supporting part 4a having an opening portion 4a1 (corresponding to an example of a first opening portion) on the side facing a base part 5.

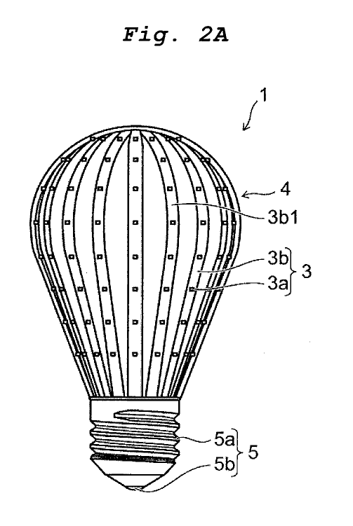

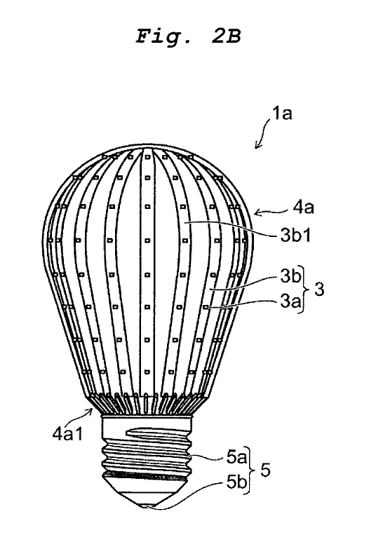

FIGS. 2A and 2B are schematic diagrams illustrating an example of a light source part 3 of the illuminating devices 1 and 1a, respectively, shown in FIGS. 1A and 1B.

In addition, FIG. 2A shows the illuminating device 1 equipped with a supporting part 4 which is not configured with an opening portion, and FIG. 2B shows the illuminating device la having a supporting part 4a having an opening portion 4a1 at an end thereof which faces the base part 5.

Additionally in FIGS. 1A and 1B, the illuminating devices 1 and 1a have a main body part 2, a light source part 3, a supporting part 4, a base part 5, and a control part 6.

The main body part 2 has an internal space that can accommodate the control part 6.

One end portion of the main body part 2 resides within the base part 5. In this case, the side surface of one end portion of the main body part 2 can be anchored to the inner wall surface of the base part 5.

There is no specific restriction on the material of the main body part 2. In consideration of dissipation of the heat generated in the control part 6, it is preferred that the main body part 2 be made of a material with a high thermoconductivity.

Examples of materials with high thermoconductivity include aluminum (Al), copper (Cu), iron (Fe), nickel (Ni), alloys thereof, and other metal materials. However, the present embodiment is not limited to these materials. Inorganic materials such as aluminum nitride (AlN), silicon carbide (SiC), and organic materials such as high-thermoconductivity resins, etc. may also be adopted.

As shown in FIGS. 1A-2B, light emitting elements 3a and a substrate part 3b are arranged in the light source part 3.

The light emitting elements 3a may be, for example, light emitting diodes, organic light emitting diodes, laser diodes, or other so-called spontaneous light emitting elements. Multiple light emitting elements 3a are arranged on the substrate part 3b. In this case, the light emitting elements 3a may be arranged in a regular configuration of an array, such as a configuration with equal spacing, or they may be arranged in any configuration.

That is, the light emitting elements 3a may be dispersed on the interior surface of the supporting part 4, and may be placed on the supporting part 4 such that at least a light emitting surface (exit plane) of each light emitting element is in contact with the supporting part 4. In this case, in order to have the heat that is generated in the light emitting elements 3a transferred at a high efficiency to the supporting part 4, the light emitting elements 3a are at least partially embedded in the supporting part 4, as well as being dispersed over the inner surface side of the supporting part 4.

The substrate part 3b can have a wiring pattern not shown in the figure. Furthermore, the light emitting elements 3a and control part 6 are electrically connected via a wiring pattern which is also not shown in the figure. With regards to the construction of the substrate part, the substrate part 3b, for example, can be a flexible substrate or other substrate which facilitates assembly of the light emitting elements 3a.

The substrate part 3b is arranged to extend in the axial direction of the illuminating device 1. The substrate part 3b may also be composed of multiple belt-shaped portions arranged individually or connected with each other. For example, the substrate parts 3b may be formed by several individual belts coming together at one end of the illuminating device, where they are connected with each other.

Curvature is formed in the substrate near the end of the light emitting device opposite to the side facing the base part 5.

There is no specific restriction on the appearance and shape of the multiple substrate parts 3b. For example, the general shape of the multiple substrate parts 3b may be similar to, or different than that of the globe of a conventional incandescent light bulb similar to the embodiments shown in FIGS. 2A and 2B.

The supporting part 4 is disposed so as to cover at least the light emitting surface formed by the light emitting elements 3a.

The supporting part 4 is attached to base part 5 at one end thereof. The supporting part 4 may partially or completely enclose an internal space, and its exterior surface is exposed to the ambient atmosphere.

There is no specific restriction on the shape of the supporting part 4. For example, when the multiple substrate parts 3b are formed in a shape similar to that of the globe of a conventional incandescent light bulb, the shape of the supporting part 4 can be formed in a similar shape which provides a housing to cover the multiple substrate parts 3b.

The supporting part 4 can be formed using a light transmissive material. Examples of light transmissive materials include, for example, light transmissive resin materials such as silicone resin, polycarbonate, and inorganic materials such as glass, and light transmissive ceramics.

Also, the supporting part 4 may contain a diffusing agent that can diffuse light emitted from the light emitting elements 3a. Examples of the diffusing agents that may be used include fillers such as silicon oxide, metal oxide, and the like, micro particles of polymers, etc. As the diffusing agent is contained in the supporting part 4, the light emitted from the light emitting elements 3a can be diffused, thereby decreasing the unevenness in luminance.

The base portion of the supporting part 4, corresponding to the end of the supporting part 4 where base part 5 is located, may be anchored to the main body part 2.

Also, as in the illuminating device 1a shown in FIGS. 1B and 2B, multiple opening portions 4a1 are formed on the end portion of the supporting part 4a, near where the supporting part 4A is attached to the base part 5. The multiple opening portions 4A1 provide fluid communication between the internal space of the supporting part 4a and areas external to the illuminating device 1. The opening portions 4a1 enable external air to be drawn into the interior of the supporting part 4a, and/or enable the air inside the supporting part 4a to be exhausted through the opening portions 4a1.

The base part 5 is disposed around an end of the main body part 2 which is opposite to the end to which the supporting part 4 is attached. The base part 5 may have a shape that allows it to be attached in a socket suitable for the attachment of an ordinary incandescent light bulb. For example, the base part 5 may have a shape similar to the E26 shape or E17 shape defined in the JIS standard, as well as other standards used throughout the world. Here, the shape of the base part 5 is not limited to the shape shown in the example, and appropriate changes can be adopted. For example, the base part 5 may also have a pin-shaped terminal of the type used for fluorescent lamps. Also, it may have an L shaped terminal adopted for hooked ceiling lamps.

The base part 5, for example, may be formed using an electrically conductive material such as a metal. Alternatively, the portion which connects with the external power supply may be formed from an electrically conductive material such as a metal, while the remaining portion is formed from a resin or the like.

The base part 5 shown as an example in FIGS. 1A and 1B and 2A and 2B, has a threaded cylindrical-shaped shell part 5a. The base part 5 also has an eyelet part 5b arranged on the end of the threaded cylindrical-shaped shell part 5a facing away from supporting part 4. The shell part 5a and the eyelet part 5b are electrically connected with the control part 6, which will be explained later. Consequently, electrical connection can be made between an external power supply (not shown in the figure) and the control part 6 via the shell part 5a and the eyelet part 5b. In the case where the main body part 2 is made of metal or the like, an insulating part made of an adhesive or the like is arranged between the main body part 2 and the base part 5.

The control part 6 is arranged in the internal space of the main body part 2. An insulating part not shown in the figure is arranged appropriately between the main body part 2 and the control part 6 to realize electrical insulation.

The control part 6 may have a control circuit that supplies electric power to the light source part 3. In this case, for example, the control circuit converts the commercial AC power supply, for example 100VAC to 120VAC, to DC power that is fed to the light source part 3. Also, the control part 6 may have a light adjusting circuit that adjusts the light of the light source part 3. In this case, the light adjusting circuit can perform light adjustment for each of the light emitting elements or for each of the group of light emitting elements.

In the illuminating devices 1 and 1a shown in FIGS. 1A-2B, heat is generated in the light emitting elements 3a and the control part 6 during operation of the illuminating devices 1 and 1a.

In this case, the heat generated from the light emitting elements 3a is dissipated to the exterior via supporting parts 4 and 4a.

On the other hand, the heat generated in the control part 6 is dissipated to the outer side via the main body part 2 and the base part 5.

Consequently, in the illuminating devices 1 and 1a, the heat dissipation route associated with light emitting elements 3a and the heat dissipation route associated with the control part 6 can be isolated from each other. Also, as multiple opening portions 4a1 are formed at the end of supporting part 4a near base part 5, it is possible to decrease heat conduction between the supporting part 4a and the main body part 2. By decreasing dissipation of heat of the control part 6 to the light emitting elements 3a, it is possible to proportionally reduce the temperature of the light emitting elements 3a.

In the illuminating devices 1 and 1a, the light emitting elements 3a, which develop heat as light sources, are dispersed on the supporting parts 4 and 4a in order to lessen heat density.

Also, in the illuminating devices 1 and 1a, supporting parts 4 and 4a are arranged between the light emitting elements 3a, which develop heat as light sources, and the ambient atmosphere. This arrangement enables a reduction of the thermal resistance between the light emitting elements 3a and the ambient atmosphere, which increases thermal conduction between the light emitting elements 3a and ambient atmosphere.

In the illuminating devices 1 and 1a, the heat generated in the light emitting elements 3a is dissipated to the exterior via supporting parts 4 and 4a. Consequently, in the illuminating devices 1 and 1a, the surface of the supporting parts 4 and 4a can serve as the heat dissipation surface.

Also, for the illuminating device 1a, as multiple opening portions 4a1 are arranged on the end of supporting part 4a that faces base part 5, the internal air of the supporting part 4a and ambient air from the atmosphere can flow therein.

Consequently, for the illuminating devices 1 and 1a, it is possible to improve the ability of the light emitting elements 3a to dissipate heat to the internal air surrounded by the supporting parts 4, 4a so that the heat may eventually transferred to the exterior of the illuminating device 1a through the supporting parts 4, 4a. As a result, in the illuminating devices 1 and 1a, it is possible to increase the electric power that can be provided to the light emitting elements 3a. Through increasing power in this manner, the light emission from the illuminating devices 1 and 1a may be enhanced.

However, as in the case of a conventional illuminating device using light emitting elements in the light source portion, if the light emitting surface is disposed perpendicular to the axial direction of the illuminating device, the light distribution angle becomes narrower than that of a conventional incandescent light bulb.

In contrast, for the illuminating devices 1 and 1a, the dispersed arrangement of light emitting elements 3a on the supporting parts 4 and 4a and the axially oriented position of the substrate parts 3b, enable the light distribution angle to be increased, thus providing enhanced light emission from the illuminating devices 1 and 1a.

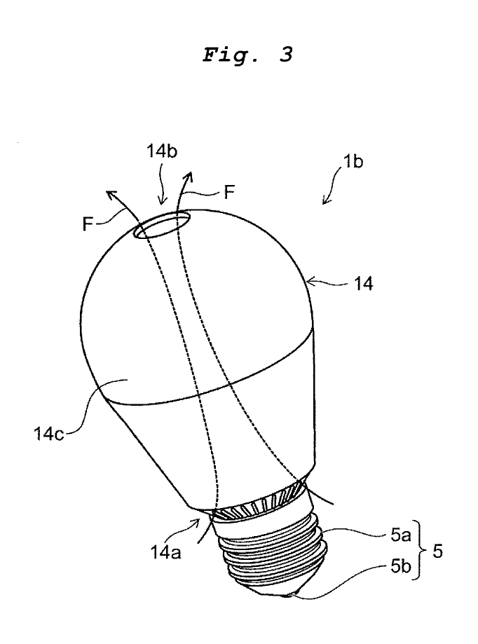

FIG. 3 is a perspective diagram illustrating an example of the illuminating device related to an additional embodiment of the present disclosure.

The illuminating device 1b shown as an example in FIG. 3 has the same main elements as those of the illuminating devices 1 and 1a. Here, on the supporting part 14 arranged on the illuminating device 1b, opening portions 14a and opening portion 14b (corresponding to an example of a second opening portion) are provided. In addition, the supporting part 14 is the same as the supporting part 4a shown previously, with the exception of opening portion 14b which is formed only in supporting part 14.

Multiple opening portions 14a are arranged at the first end of the supporting part 14 adjacent the base part 5, and there is effectively no interruption between the internal space partially enclosed by supporting part 14 and the space external to the illuminating device 1b.

The opening portion 14b is arranged at the second end of supporting part 14 which faces away from the base part 5. This opening portion 14b provides further fluid communication between the internal space partially enclosed by supporting part 14 and the ambient environment external to the supporting part 14 of illuminating device 1b.

The shape, configuration, position, number and size, etc., of the opening portions 14b are not limited to the example shown in FIG. 3, and appropriate changes can be made.

For example, the supporting part 14 may have opening portions 14a and opening portion 14b which are separated from each other in the axial direction of the illuminating device 1b.

Alternatively, multiple opening portions 14b may be formed on the side surface 14c of the supporting part 14.

Multiple opening portions 14b with a small size may also be formed.

In order to suppress invasion of particles from the opening portions 14b into the supporting part 14, a lid or filter (not shown in the figure) which is permeable to air may be disposed upon each of the opening portions 14b. For example, a mesh-shaped lid may be arranged on the opening portions 14b.

For the illuminating device 1b, just as for the illuminating devices 1 and 1a, heat dissipation properties can be improved, and the light distribution angle can be increased.

In this case, for the illuminating device 1b, opening portions 14a and opening portions 14b are located apart from each other. Consequently, it is possible to form an air flow F inside the supporting part 14. The air flow F facilitates further improvements of the heat dissipation properties at the sides of light emitting elements 3a. Also, because increased power may be provided to the light emitting elements 3a, it is possible to further improve the light emission from the illuminating device 1b. In addition, the air flow direction in the supporting part 14 may be changed by adjusting the direction of attachment of the illuminating device 1b. For example, as shown in FIG. 3, air may enter through the opening portions 14a and exhausted from opening portion 14b. Also, air may enter through the opening portion 14b and exhausted from the opening portions 14a.

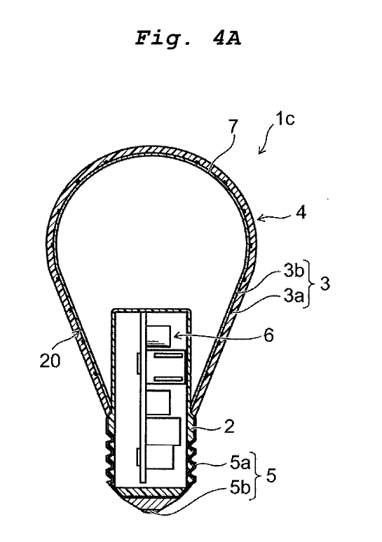

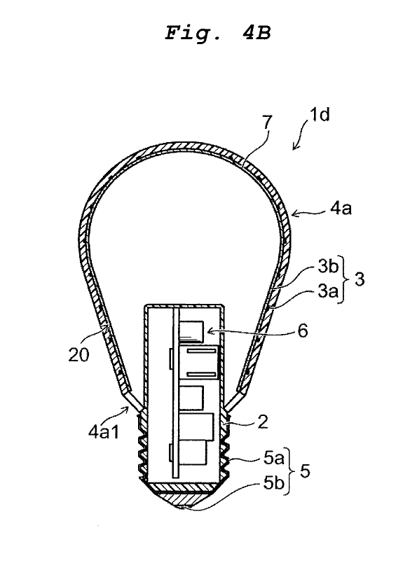

FIGS. 4A and 4B are schematic cross-sectional views illustrating an example of the illuminating device related to another embodiment.

FIG. 4A shows an illuminating device 1c equipped with a supporting part 4 not having an opening portion disposed thereon, and FIG. 4B shows an illuminating device 1d equipped with a supporting part 4a with an opening part 4a1 formed on a first end thereof adjacent the base part 5.

The illuminating devices 1c and 1d shown in FIGS. 4A and 4B, just as for the illuminating devices 1 and 1a, the following parts are included: a main body part 2, a light source part 3, supporting parts 4 and 4a, a base part 5, and a control part 6. In addition, for the illuminating device 1c, a heat dissipating part 7 is arranged on an interior surface of the supporting part 4.

The heat dissipating part 7 dissipates the heat generated by light emitting elements 3a. Consequently, the heat dissipating part 7 should be made of a material with a high thermoconductivity.

Example materials with high thermoconductivity include metal materials such as aluminum (Al), copper (Cu), iron (Fe), nickel (Ni), and alloys thereof. However, the present embodiment is not limited to these materials. Inorganic materials such as aluminum nitride (AlN), silicon carbide (SiC), and organic materials such as high-thermoconductivity resins, may also be adopted.

In addition, the heat dissipating part 7 also serves to reflect light which is emitted from light emitting elements 3a. A portion of the light from the light emitting elements 3a is incident upon the heat dissipating part 7 and the portion is reflected at the interface between the supporting parts 4 and 4a and the ambient environment. In order to configure the heat dissipating part 7 to also reflect light in this manner, the heat dissipating part 7 may be made of a material with high thermoconductivity and higher light reflectivity than the supporting parts 4 and 4a.

Examples of materials having high thermoconductivity and high light reflectivity include metal materials such as aluminum (Al), silver (Ag), copper (Cu), iron (Fe), nickel (Ni), and alloys thereof.

In addition, a reflective layer 20 may be formed on an outer surface of the heat dissipating part 7 between the heat dissipating part 7 and the supporting parts 4 and 4a. The reflective layer 20 is utilized to reflect light from the interface between the supporting parts 4 and 4a and the ambient atmosphere towards the heat dissipating part 7. The reflective layer 20 may be made of a material with a high light reflectivity. For example, the reflective layer 20 may be made of metal materials such as aluminum (Al), gold (Au), silver (Ag), copper (Cu), palladium (Pd), rhodium (Rh), alloys thereof, organic materials with high reflectivity (for example, such as white paint containing white grains such as titanium oxide, zinc oxide or the like.). The reflective layer 20 may be formed by using a plating method, vapor deposition method, sputtering method, etc., to coat the reflective material onto the surface of the heat dissipating part 7. In addition, the reflective layer 20 may be formed using a cladding method to form a layer of reflective material on the surface of the heat dissipating part 7.

The heat dissipating part 7 can be arranged so that it covers the interior surface of the supporting parts 4 and 4a and the surface of the substrate part 3b which faces the interior surface of the supporting parts 4 and 4a. In this case, the heat dissipating part 7 can be arranged to cover the entire interior surface of the supporting parts 4 and 4a, or arranged on a portion of the interior surface.

There is no specific restriction on the thickness dimension of the heat dissipating part 7, and it can be altered as necessary.

The region where the heat dissipating part 7 is disposed and the thickness dimension of the heat dissipating part 7 can be determined based on the amount of heat generated from the light emitting elements 3a, the configuration and number of the light emitting elements 3a, the size of the supporting parts and 4a, the environmental conditions under which the illuminating devices 1c and 1d are used, etc.

For formation of the heat dissipating part 7, for example, the light source part 3 having light emitting elements 3a arranged thereon is disposed on the interior surface of the supporting parts 4 and 4a, and then the heat dissipating part 7 is formed on the interior surface of the supporting parts 4 and 4a.

Also, in forming the heat dissipating part 7, the substrate part 3b is bonded on the outer surface of the heat dissipating part 7 so that the light source part 3 is coupled to the heat dissipating part 7, and so that the supporting parts 4 and 4a are formed to cover the light source part 3.

In this case, the heat dissipating part 7 may be formed using a plastic processing method, cutting processing method, or other machine processing method.

Illuminating devices 1c and 1d, like devices 1 and 1a facilitate the same improvements related to heat dissipation properties and increasing the light distribution angle.

With regards to illuminating devices 1c and 1d, the heat dissipating part 7 is disposed on the interior surface of the supporting parts 4 and 4a. Consequently, for the illuminating devices 1c and 1d, the ability of light emitting elements 3a to dissipate heat in the direction of the heat dissipating part 7 can be further improved. As a result, for the illuminating devices 1c and 1d, the light beam emission may be further improved by supplying the light emitting elements 3a with larger amounts of electric power. Also, the heat dissipating part 7 when adapted to reflect incident light, or the reflective layer 20 being disposed near the inner surface of supporting parts 4 and 4a, may further facilitate increased efficiency in light output by reflecting light from the light emitting elements 3a toward ambient environment.

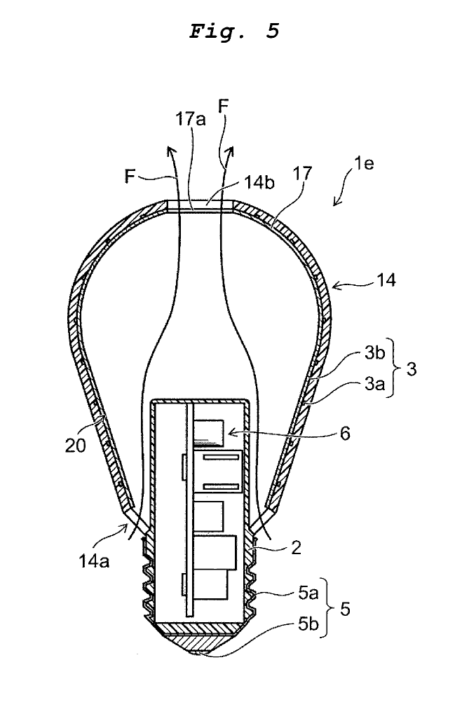

FIG. 5 is a schematic cross-sectional view illustrating an example of an illuminating device 1e related to another embodiment.

The illuminating device 1e shown in FIG. 5 as an example has the same elements as those of the illuminating devices 1c and 1d.

Here, as previously described in the embodiment of FIG. 3, the supporting part 14 has opening portions 14a and opening portion 14b formed therein.

Also, an opening portion 17a is formed in the heat dissipating part 17. The heat dissipating part 17 is the same as the heat dissipating part 7, with the exception that opening portion 17a is formed in heat dissipating part 17.

By means of the opening portion 14b formed in the supporting part 14 and the opening portion 17a formed in the heat dissipating part 17, the internal space partially enclosed by the supporting part 14 is in communication with the environment external to the illuminating device 1e.

Consequently, just as with the illuminating device 1b shown in FIG. 3, air flow F may occur without restriction within the supporting part 14. As a result, it is possible to increase the dissipation of heat from the heat dissipating part 17. Also, the air flow direction inside the supporting part 14 changes corresponding to the attachment orientation of the illuminating device 1e. For example, as shown in FIG. 5, air may enter through opening portions 14a and exit from the opening portion 17a and opening portion 14b, or air may enter through opening portion 14b and opening portion 17a and exit through opening portions 14a.

For the illuminating device 1e, just as in illuminating devices 1 and 1a, heat dissipation properties can be improved, and the light distribution angle can be increased.

Also, because heat dissipating part 17 is disposed in the illuminating device 1e, similarly to illuminating devices 1c and 1d, the heat dissipation property of the light emitting elements 3a can be improved.

Also, for the illuminating device 1e, as opening portion 14b and opening portion 17a are formed thereon, the air flow F can be formed inside the supporting part 14.

In operation of the illuminating device 1e, because of air flow F can occur within the boundaries formed by supporting part 14, the dissipation of heat from the heat dissipating part 17 is enhanced. As a result, in the illuminating device 1e, additional electric power can be supplied to the light emitting elements 3a in a manner that enhances the light output of the illuminating device 1e.

In addition, when the heat dissipating part 17 has the function of reflecting the incident light, or when the reflective layer 20 is formed thereon, it is possible to increase the efficiency in output of light.

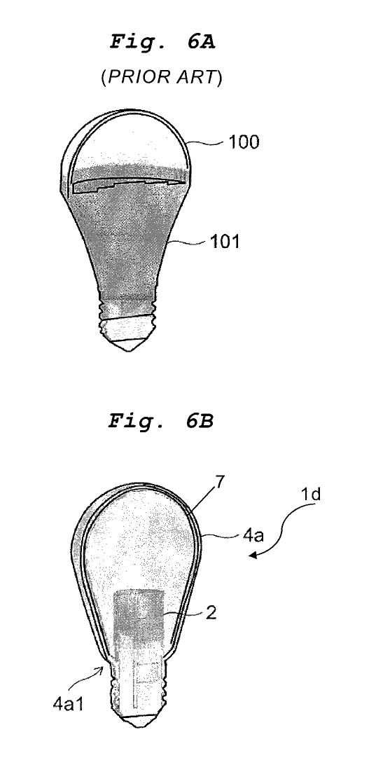

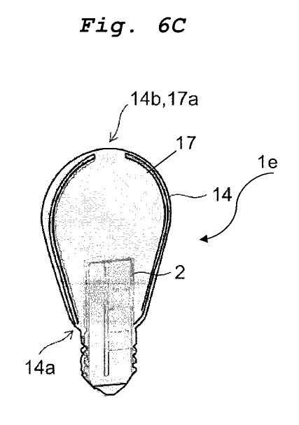

FIGS. 6A to 6C are schematic diagrams illustrating an example of heat dissipation from illuminating devices.

FIG. 6A shows the case of a conventional illuminating device having multiple light emitting elements arranged on an upper end of a substrate 101, and a globe 100 arranged to cover the multiple light emitting elements.

FIG. 6B shows the case of the illuminating device 1d having the heat dissipating part 7, as described previously in reference to FIGS. 4A and 4B. FIG. 6C shows the case of the illuminating device 1e having the heat dissipating part 7, and opening portions 14b and 17a, as described previously in reference to FIG. 5.

FIGS. 6A to 6C also illustrate the distribution of temperature of illuminating devices in simulated operations. In this case, the applied electric power is the same in each FIG., and the environmental (i.e., ambient) temperature is about 25 degrees C.

In FIGS. 6A to 6C, the temperature distribution is illustrated by a shading over the depicted area. That is, the higher the temperature, the darker the corresponding shading; and, the lower the temperature, the lighter the corresponding shading.

As shown in FIG. 6A, for a conventional illuminating device, the temperature of the substrate 101 having the light emitting elements arranged on an upper end of a substrate 101 is higher than the temperature of the globe 100. That is, for the conventional illuminating device, the heat generated by the light emitting elements cannot be dissipated with high efficiency, which is undesirable. In this case, usually, because the light emitting elements have a prescribed heat-resistant temperature, if the heat dissipation is poor, the power that can be applied to the elements is limited. Consequently, it is difficult to improve the light output.

As shown in FIG. 6B, for the illuminating device 1d having the heat dissipating part 7, although the temperature of the main body part 2 rises, there will be a decrease in temperature of the supporting part 4a on which the light emitting elements 3a (not shown) are arranged.

That is, it is possible to isolate the heat dissipation route associated with the light emitting elements 3a and the heat dissipation route associated with the control part 6.

As mentioned previously, for the illuminating device 1d, as the light emitting elements 3a are the sources of heat, it is possible to decrease the heat density by dispersing the light emitting elements 3a on the supporting part 4a.

In addition, for the illuminating device 1d, as only a supporting part 4a is arranged between the light emitting elements 3a, which act as the heating source, and the ambient atmosphere, it is possible to decrease the thermal resistance between the light emitting elements 3a and the ambient atmosphere.

Also, for the illuminating device 1d, the heat generated by the light emitting elements 3a is dissipated outside of the illuminating device 1d via the supporting part 4a. Consequently, the surface of the supporting part 4a serves as the heat dissipating surface.

In addition, for the illuminating device 1d, because multiple opening portions 4a1 are configured in the first end of supporting part 4a adjacent the base part 5, the air within the supporting part 4a is in communication with the ambient atmosphere.

Consequently, as shown in FIG. 6B, it is possible to improve the heat dissipation property of the light emitting elements 3a. As a result, compared with the conventional illuminating device, the electric power that can be supplied to the light emitting elements 3a can be increased, thereby enabling improvement of the light output.

As shown in FIG. 6C, for the illuminating device 1e having the heat dissipating part 17, the opening portion 14b, and the opening portion 17a, it is possible to form an air flow F inside the supporting part 14. Consequently, it is possible to further improve the heat dissipation property on the backside of the light emitting elements 3a. As a result, it is possible to increase the supply of electric power that can be applied to the light emitting elements 3a, and it is possible to further improve the light output.

In addition, for illuminating device 1e, the temperature of the main body part 2 having the control part 6 inside thereof can also be decreased.

According to the embodiments, it is possible to realize an illuminating device that can improve the heat dissipation property. Additionally, light output can be increased due to an increase in electrical power applied to the light emitting elements which is made possible by the increased heat dissipation property of the illuminating devices as described herein.

While certain embodiments have been described, these embodiments have been presented by way of example only, and are not intended to limit the scope of the embodiments. Indeed, the novel embodiments described herein may be embodied in a variety of other forms; furthermore, various omissions, substitutions and changes in the form of the embodiments described herein may be made without departing from the spirit of the embodiments. The accompanying claims and their equivalents are intended to cover such forms or modifications as would fall within the scope and spirit of the embodiments. Further, each of the above embodiments may be performed by being combined mutually.

What is claimed is:

1. An illuminating device comprising:
a base part;
a supporting part having a first end coupled to an end of the base part, the supporting part at least partially enclosing an internal space and having an outer surface thereof exposed to ambient atmosphere; and
a plurality of light emitting elements formed on multiple substrate parts disposed on an inner surface of the supporting part, wherein each of the light emitting elements has a light emitting surface in at least partial contact with the supporting part.

2. The illuminating device of claim 1, wherein the first end of the supporting part includes a plurality of first openings formed therein between the base part and the supporting part, each of the first openings configured to facilitate circulation of air into and out of the internal space.

3. The illuminating device of claim 2, further comprising:
a heat dissipating part disposed on an interior side of the supporting part.

4. The illuminating device of claim 3, further comprising:
a reflective layer configured to reflect light towards the supporting part.

5. The illuminating device of claim 1, wherein the supporting part includes a second end having a second opening formed therein that is in fluid communication with the plurality of first openings.

6. The illuminating device of claim 5, further comprising:
a heat dissipating part disposed on an interior side of the supporting part.

7. The illuminating device of claim 6, further comprising:
a reflective layer configured to reflect light towards the supporting part.

8. The illuminating device of claim 1, further comprising:
a heat dissipating part disposed on an interior side of the supporting part.

9. The illuminating device of claim 8, further comprising:
a reflective layer configured to reflect light towards the supporting part.

10. The illuminating device of claim 1, wherein the plurality of light emitting elements are formed along a longitudinal direction of the supporting part.

11. The illuminating device of claim 1, wherein the supporting part comprises a diffusing member configured to diffuse light emitted by the light emitting elements.
